(19) United States
(12) Patent Application Publication
(10) Pub. No.: US 2023/0052540 A1
(43) Pub. Date: Feb. 16, 2023

(54) TREND-INFORMED DEMAND FORECASTING

(71) Applicant: International Business Machines Corporation, Armonk, NY (US)

(72) Inventors: Richard J. Tomsett, Southampton (GB); Smitkumar Narotambhai Marvaniya, BANGALORE (IN); Geeth Ranmal de Mel, Warrington (GB); Jitendra Singh, Noida (IN); NICOLAS ELIE GALICHET, Warrington (GB); Komminist Weldemariam, Ottawa (CA); Shantanu R. Godbole, Bangalore (IN)

(21) Appl. No.: 17/401,548

(22) Filed: Aug. 13, 2021

(51) Int. Cl. G06N 3/08; G06N 20/00; G06N 3/04

(52) U.S. Cl. CPC G06N 3/08; G06N 20/00; G06N 3/0427; G06N 3/0454

(57) ABSTRACT

In an approach to jointly learning uncertainty-aware trend-informed neural network for a demand forecasting model, a machine learning model is trained to capture uncertainty in input forecasts. The uncertainty in a latent space is represented using an auto-encoder based neural architecture. The uncertainty-aware latent space is modeled and optimized to generate an embedding space. A time-series regressor model is learned from the embedding space. A machine learning model is trained for trend-aware demand forecasting based on said time-series regressor model.

### BACKGROUND

The present invention relates to predicting demand, and more particularly, to a method for trend-informed demand forecasting. The present invention further relates to a computer program product comprising computer-readable program code that enables a processor of a processing system to implement such a method. The present invention further relates to a system for trend-informed demand forecasting.

Extreme events in normal temporal-based trends can impact supply chains. For example, extreme weather and/or climate events (such as floods, droughts, tropical cyclones, etc.) can test the resilience of supply chains. Consequently, some companies are aware of trend-related hazards and may be well-informed about their potential exposure to such hazards. Nonetheless, even though companies may have alternative supply chain arrangements or plans, most lack a fundamental understanding of their vulnerability to abnormal or extreme events.

For instance, many companies use short-term weather forecasts to predict demand Some companies may even recognize how mid to long-term seasonal trends and/or sudden events impact their demand However, mid to long-term forecasts may have high degrees of uncertainty and/or have a complex impact on demand forecasting (e.g., retail product demand forecasting).

It may therefore be desirable to understand how to represent mid to long-term trend forecasts and/or extreme events, to estimate product and/or service demands more accurately. More accurate demand forecasting may, for example, facilitate the development of effective trend-aware applications (e.g., demand prediction at a retail node in a supply chain, lead-time forecasting, etc.) which enable resilient decisions and policies.

### SUMMARY

The present invention seeks to provide a method for jointly learning uncertainty-aware trend-informed neural network for improved demand forecasting modelling. Such a method may be computer-implemented. The present invention further seeks to provide a computer program product including computer program code for implementing the proposed concepts when executed on a processor. The present invention yet further seeks to provide a system for jointly learning uncertainty-aware trend-informed neural network.

According to an embodiment of the present invention there is provided a computer-implemented method for jointly learning uncertainty-aware trend-informed neural network for an improved demand forecasting model. The method comprises training a machine learning model to capture uncertainty in input trend forecasts. The method also comprises representing said uncertainty in a latent space using an auto-encoder based neural architecture. The method further comprises modeling and optimizing the uncertainty-aware latent space to generate an embedding space and learning a time-series regressor model from the embedding space. A machine learning model for trend-aware demand forecasting is then trained using said models.

Embodiments may be employed in combination with conventional/existing demand forecasting methods and/or systems. In this way, embodiments may integrate into legacy systems so as to improve and/or extend their functionality and capabilities. An improved demand forecasting system may therefore be provided by proposed embodiments.

According to another embodiment of the present invention, there is provided a computer program product for jointly learning uncertainty-aware trend-informed neural network, the computer program product comprising a computer readable storage medium having program instructions embodied therewith, the program instructions executable by a processing unit to cause the processing unit to perform a method according to one or more proposed embodiments when executed on at least one processor of a data processing system.

According to yet another aspect, there is provided a processing system comprising at least one processor and the computer program product according to one or more embodiments, wherein the at least one processor is adapted to execute the computer program code of said computer program product.

According to another aspect, there is provided a system for jointly learning uncertainty-aware trend-informed neural network for an improved demand forecasting model. The system comprises a training component configured to train a machine learning model to capture uncertainty in input trend forecasts. The system also comprises a neural network component configured to represent said uncertainty in a latent space using an auto-encoder based neural architecture. The system further comprises a modelling component configured to jointly model and optimize the uncertainty-aware latent space so as to generate an embedding space, and to learn a time-series regressor model from the embedding space. The system is configured to train a machine learning model for trend-aware demand forecasting using the models.

Thus, there may be proposed one or more concepts for providing an improved demand forecasting model. Unlike existing demand forecasting approaches, proposed concepts may capture an uncertainty associated with a temporal-based forecast. Further, proposed concepts may prevent systematic errors in forecasts from propagating into demand forecasting models. Proposed concepts may also improve understanding and/or quantification of extreme events (e.g., extreme weather/climate events, or sudden energy consumption change events) in relation to demand prediction tasks. For example, embodiments may provide a system and/or method to jointly learn uncertainty-aware demand forecasting model by exploring advanced methods such as trend-informed neural network.

### BRIEF DESCRIPTION OF THE DRAWINGS

Preferred embodiments of the present invention will now be described, by way of example only, with reference to the following drawings, in which:

FIG. 1 depicts a pictorial representation of an example distributed system in which aspects of the illustrative embodiments may be implemented;

FIG. 2 is a block diagram of an example system in which aspects of the illustrative embodiments may be implemented;

FIG. 3 depicts an uncertainty-aware learning architecture comprising an uncertainty aware seasonal forecast representation of exogenous variables according to a proposed embodiment;

FIGS. 4A-4C depict components of an uncertainty aware seasonal forecast representation of exogenous variables according to a first embodiment;

FIG. 5 depicts a method of generating a learnable uncertainty-aware histogram representation using the examples of FIG. 4A-4C;

FIG. 6 depicts a method of employing an autoencoder with a trend-aware loss function according to an embodiment;

FIG. 7 illustrates an exemplary architecture and workflow of a proposed embodiment; and

FIG. 8 illustrates a system according to another embodiment.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a (processing) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server or a collection of PCs and/or servers connected via a network such as a local area network, the Internet and so on to cooperatively execute at least one embodiment of the methods of the present invention.

Proposed are concepts to jointly learn uncertainty-aware demand forecasting model by exploring advanced methods such as trend-informed neural networks. Such concepts may capture uncertainty in trend forecasts (e.g., seasonal weather forecasts) and represent this as a latent space using an auto-encoder based neural architecture. Concepts may also jointly optimize such an uncertainty-aware latent space (i.e., embedding) and learn a time-series regressor model from the embedding space. Yet further, embodiments may implement a concept of a reconstruction cost that enforces hierarchical constraints to efficiently capture the uncertainty information associated with the trend forecasts (e.g., mean, variance, std., quartile (distribution), trend-aware histogram representation, etc.).

By way of example, embodiments may comprise jointly training a time-series regressor and trend-informed latent space encoding to provide for improved climate-aware demand forecasting. Such embodiments may capture uncertainty in input seasonal forecasts and represent such uncertainties in a latent space using an auto-encoder based neural architecture. This uncertainty-aware latent space may be jointly optimized to provide an embedding space and, from the embedding space, a time-series regressor model may be obtained. Although the example of seasonal weather forecasts is detailed, the proposed concept(s) may equally be applied to other temporal-dependent trends, such as trends in school holiday dependent activities, religious holiday-related trends, energy usage forecasts (short-term or long-term), etc.

Embodiments may also employ a concept of determining reconstruction costs to enforce hierarchical constraints and capture the uncertainty information associated with the trend forecasts (e.g., mean, variance, standard, quartile/distribution, trend-aware histogram representation).

Also, some proposed embodiments may represent and translate outputs of trend-aware demand predictions by: (a) learning the encoded representation of mid- to long-term forecasts; (b) enabling trust and guarantee on said predictions using the trend-informed neural network; and (c) determining an impact metric to measure the effectiveness of a trend-aware demand forecasting for a subset of products-locations pairs.

Accordingly, there are proposed concepts for quantifying and decomposing the uncertainty in an input space and model space to help/support decision making (e.g., in relation to demand/supply management).

Some embodiments may, for example, comprise learning a sub-neural network using auto-encoder architecture. Embodiments may also introduce a loss function that indicates how well climate forecasts are encoded while estimating demand

Proposed embodiments may be configured to monitor predicted seasonal forecasts and extreme events of each location to continuously update a spatio-temporal demand estimation. Improved spatio-temporal demand predictions may therefore be facilitated by embodiments.

Also, proposed concepts may be applicable to encoding seasonal forecasts and mid- to long-term climate forecasts for enabling climate-aware lead time prediction, inventory management, and resilient procurement. For instance, proposed embodiments may facilitate ingesting seasonal forecasts and mid-long term climate forecasts for predicting and generating seasonal scale flood hazard maps.

Reference to neural networks should be taken to refer to any type of inference network or connectionist system comprising a collection of simulated neurons (or ‘nodes’) that may be configured or trained (using training data or examples) to generate inferences or predictions from input data. Such neural networks may be otherwise referred to as artificial neural networks. Many types of neural networks are currently known, such as convolutional neural networks, and competitive networks such as generative adversarial networks. Other types of neural networks are known, and it is to be expected that variations to known types of neural networks will be developed, in addition to entirely new/different types of neural networks. It should therefore be appreciated that, although it certain types of neural network may be better suited for use in proposed embodiments, the proposed concepts may make use of any type of neural network.

Proposed embodiments may address drawbacks of current techniques, such as failure to capture uncertainty present in forecasts, and propagation of systematic errors in seasonal forecasts. Also, embodiments may cater for the many model parameters involved in mid to long-term forecast calibration.

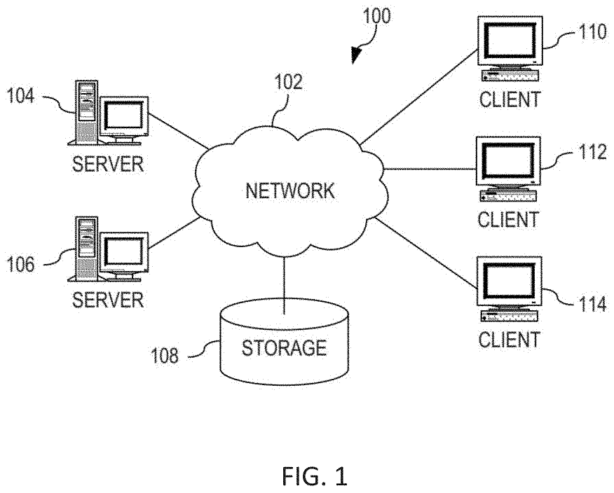

FIG. 1 depicts a pictorial representation of an exemplary distributed system in which aspects of the illustrative embodiments may be implemented. A distributed system 100 may include a network of computers in which aspects of the illustrative embodiments may be implemented. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, first server 104 and second server 106 are connected to the network 102 along with a storage unit 108. In addition, clients 110, 112, and 114 are also connected to the network 102. The clients 110, 112, and 114 may be edge devices, for example, personal computers, network computers, IoT devices, or the like. In the depicted example, the first server 104 provides data, such as boot files, operating system images, and applications to the clients 110, 112, and 114. Clients 110, 112, and 114 are clients to the first server 104 in the depicted example. The distributed processing system 100 may include additional servers, clients, and other devices not shown.

In the depicted example, the distributed system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

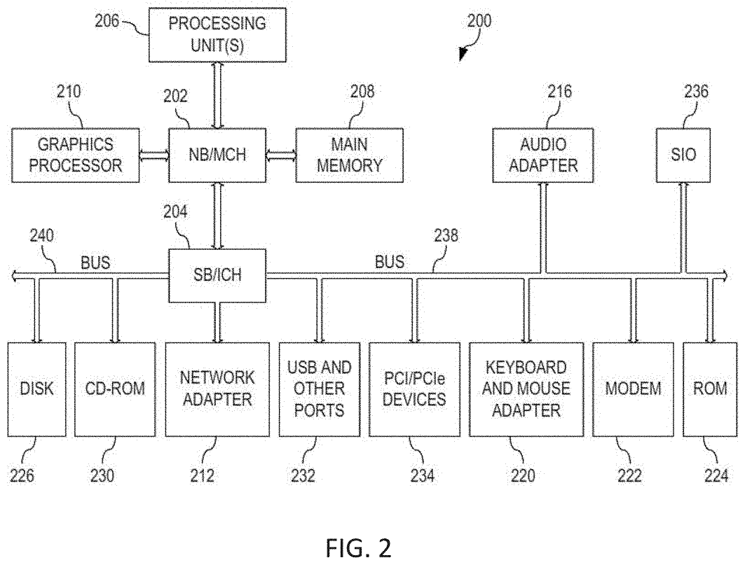

FIG. 2 is a block diagram of an example system 200 in which aspects of the illustrative embodiments may be implemented. The system 200 is an example of a computer, such as client 110 in FIG. 1, in which computer usable code or instructions implementing the processes for illustrative embodiments of the present invention may be located. For instance, a proposed embodiment may be partly implemented in a processing unit 206 of the system 200.

In the depicted example, the system 200 employs a hub architecture including a north bridge and memory controller hub (NB/MCH) 202 and a south bridge and input/output (I/O) controller hub (SB/ICH) 204. Thus, another proposed embodiment may be implemented in the memory controller hub 202 of the system 200. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) port and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200. Java and all Java-based trademarks and logos are trademarks or registered trademarks of Oracle and/or its affiliates.

As a server, system 200 may be, for example, an IBM® eServer™ System p5® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed. IBM, eServer, AIX, and System p5 are trademarks of International Business Machines Corporation, registered in many jurisdictions worldwide. LINUX® is a registered trademark of Linus Torvalds in the United States, other countries, or both.

Instructions for the operating system, the programming system, and applications or programs are located on storage devices, such as HDD 226, and may be loaded into main memory 208 for execution by processing unit 206. Similarly, one or more programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

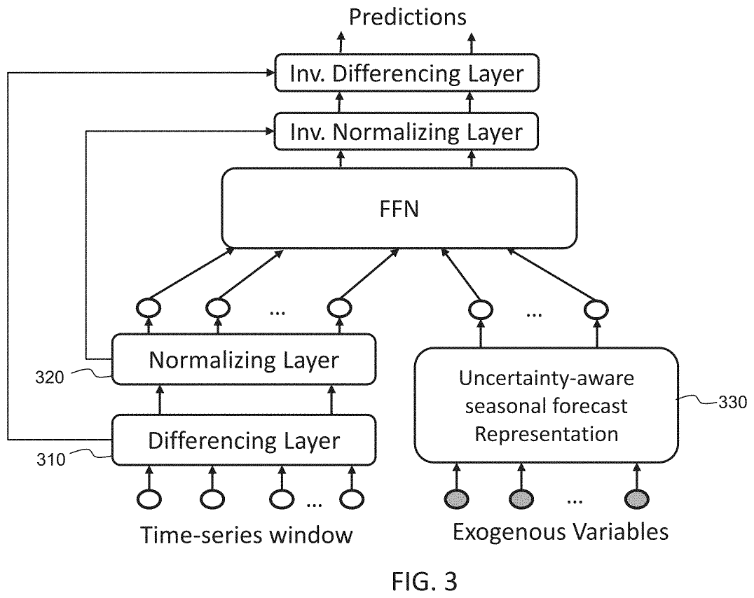

Referring to FIG. 3, there is depicted an uncertainty-aware learning architecture comprising an uncertainty aware seasonal forecast representation 330 of exogenous variables according to a proposed embodiment.

Representation of Exogenous variable in uncertainty-aware learning architecture enables data normalization (Differencing Layer 310 and Normalizing Layer 320) and also enables learnable feature representation from Exogenous variable via a dense layer, i.e., according to proposals, climatic uncertainty is enabled in the feature representation (via exogenous variables). This provides for better representation of climatic features, e.g., a derived feature construction that captures trends in the consecutive days of temperature, precipitation, etc.

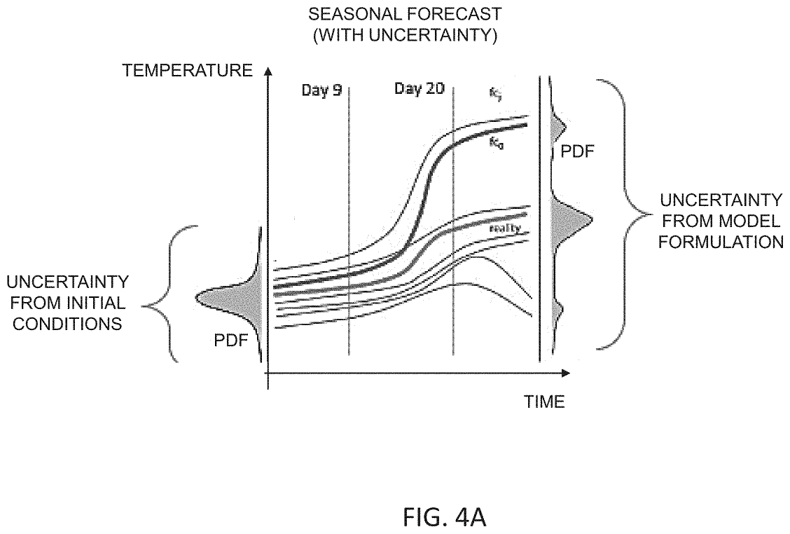

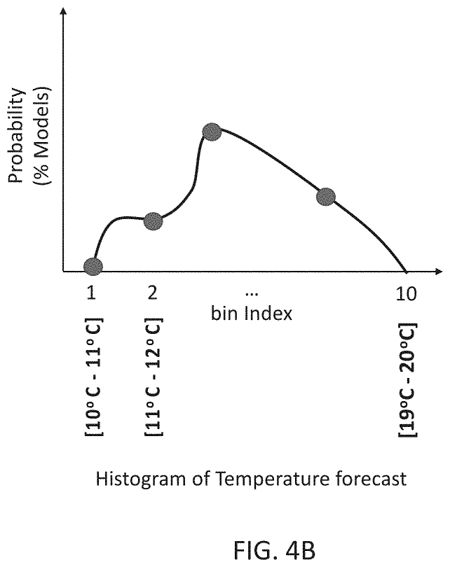

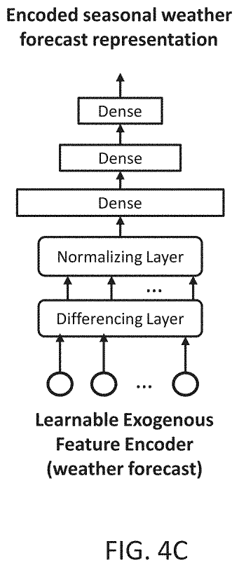

By way of example, FIGS. 4A-4C depict components of an uncertainty aware seasonal forecast representation of exogenous variables according to a first embodiment. FIG. 4A depicts a representation of a climate forecast with associated uncertainty. FIG. 4B depicts an uncertainty-aware climate forecast representation which enables the selection of an optimum temperature value in each context. FIG. 4C depicts a learnable exogenous feature encoder. That is, these three aspects may be combined in the uncertainty aware seasonal forecast representation of exogenous variables of the embodiment of FIG. 3.

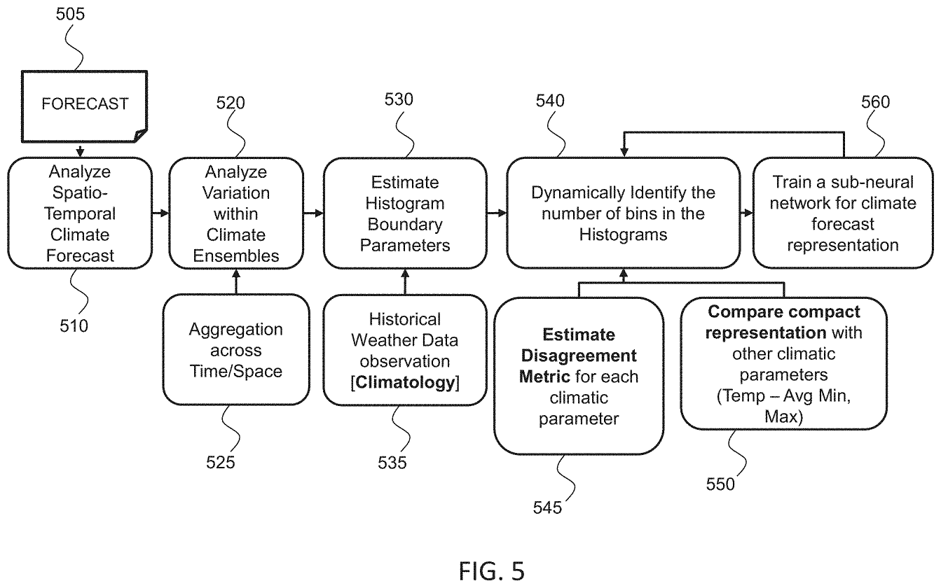

In more detail, FIG. 5 depicts a method of generating a learnable uncertainty-aware histogram representation using the examples of FIG. 4A-4C.

Step 510: Analyze spatio-temporal weather forecasts by first performing a set of data quality check to identify any anomaly in seasonal ensemble forecasts 505.

Step 520: Analyze variations of ensembles with the climatology. This is done with aggregation across time/space 525 so as to provide consistent histogram boundary representation across region(s) and time.

Step 530: Estimate the histogram representation for every product, location and time combination in training and test datasets. In doing so, step 530 takes into account historical weather (i.e., climatology) data 535.

Step 540: Dynamically identify the number of bins required to represent the uncertainty information using the following constraints: (545) Estimate the disagreement metric for each climate parameter across region and time; and (550) Compare compact representation with other climatic parameters, e.g., disagreement metric for Temperature Average versus Temperature Minimum.

Step 560: Train a sub-neural network that takes the compact uncertainty-aware histogram representation as an input and learns the latent representation of the climate forecast for demand prediction task. This is provided as feedback from the learnt sub-neural network to step 540 so as to enable dynamic histogram bin parameter determination, thereby efficiently estimating the number of bins.

FIGS. 4A-4C & 5 have been described above in relation to an uncertainty aware seasonal forecast representation of exogenous variables according to a first embodiment. However, alternative approaches may be implemented for the uncertainty aware seasonal forecast representation of exogenous variables. Purely by way of example, one alternative approach may employ a trend-informed auto-encoder. Such an approach may use a climate-aware reconstruction loss function using hierarchical constraints

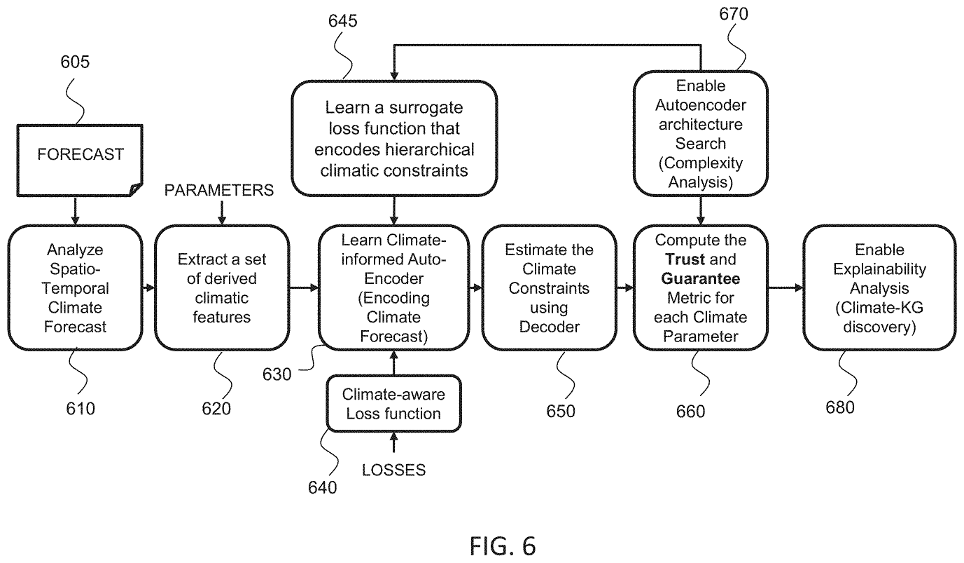

For instance, FIG. 6 depicts an exemplary method of employing an autoencoder with a climate-aware loss function.

Step 610: Analyze spatio-temporal weather forecasts by first performing a set of data quality check to identify any anomaly in seasonal ensemble forecasts 605.

Step 620: Extract a set of derived climatic features based in the analysis results from step 610.

Step 630: Learn Climate-informed Auto-Encoder (Encoding Climate Forecast) taking account of a climate-aware loss function 640. Here, the following three different climate-aware loss functions are proposed for use in training the auto-encoder neural network:

(i) Triplet loss: Enables encoding relationships. For example, relational constraints between minimum temperature and average temperature.

(ii) Data Loss: This helps in accurately estimating noise in the climate forecast by comparing it with observation data.

(iii) Reconstruction Loss: This helps in decoding climatic constraints from the latent space using decoder.

Step 630 can also take account of a surrogate loss function 645 that encodes hierarchical climatic constraints.

Step 650: Estimate the Climate Constraints using Decoder

Step 660: Compute the Trust and Guarantee Metric for each Climate Parameter. This is to estimate trust and guarantee metric against each climatic parameter that will help in enabling searching against climatic parameters. Step 660 may take account of result from an Autoencoder architecture Search (Complexity Analysis) 670

Step 680: Enable Explainability Analysis (Climate-KG discovery)

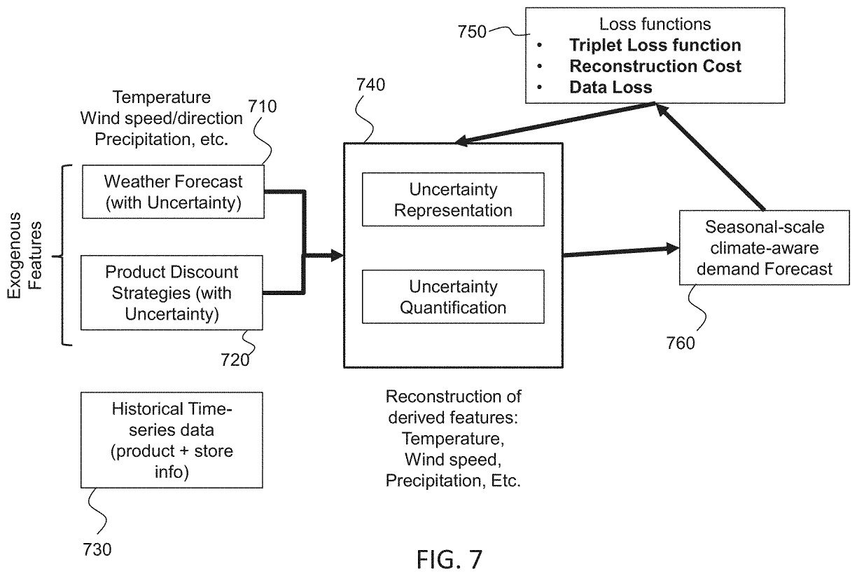

Referring now to FIG. 7, there is depicted an exemplary architecture and workflow of a proposed embodiment.

Exogenous features (such as temperature, wind speed/direction, precipitation, product strategies, etc.) are provided as inputs. In the depicted architecture, these exogenous features are provided from one or more weather forecasts 710 (with associated uncertainty), and product discount strategies 720 (with associated uncertainty). Historical time-series data (e.g., product and store information) 730 may also be accounted for.

The model 740 provides for reconstruction of derived features (e.g., temperature, wind speed, precipitation, etc.) via uncertainty representation and uncertainty quantification. The output from the model 740 is a seasonal-scale climate-aware demand forecast 760. The seasonal-scale climate-aware demand forecast 760 may be fed-back to the model via loss function 750 (e.g., representing triplet loss function, reconstruction cost, and/or data loss).

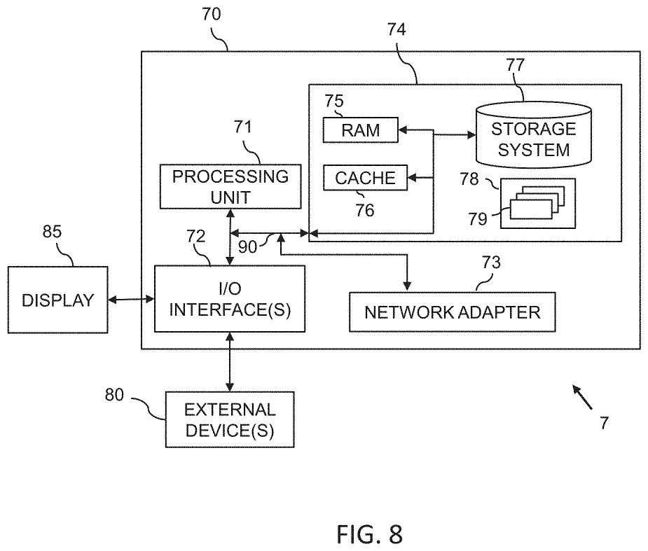

By way of yet further example, embodiments may comprise a computer system 70, which may form part of a networked system 7 illustrated in FIG. 8. For instance, a data node may be implemented in the computer system 70 (e.g., as a processing unit 71). The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media, including storage system 77. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the Input/Output (I/O) interface 72 to perform a method for providing virtual storage for temporary data storage according to a proposed embodiment. Program/utility 78, having a set (at least one) of program modules 79, may be stored in memory 74. Program modules 79 generally carry out the functions and/or methodologies of proposed embodiments for contextualizing an abnormal event.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g., to communicate with a service mesh).

In the context of the present application, where embodiments of the present invention constitute a method, it should be understood that such a method is a process for execution by a computer, i.e., is a computer-implementable method. The steps of the method therefore reflect various parts of a computer program, e.g., parts of one or more algorithms

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for jointly learning uncertainty-aware trend-informed neural network for a demand forecasting model, the method comprising:
training a machine learning model to capture uncertainty in input forecasts;
representing said uncertainty in a latent space using an auto-encoder based neural architecture;
modeling and optimizing the uncertainty-aware latent space to generate an embedding space;
learning a time-series regressor model from the embedding space; and
training a machine learning model for trend-aware demand forecasting based on said time-series regressor model.

2. The method of claim 1, further comprising:
representing and translating outputs of the trend-aware demand forecasting model using a trend-informed neural network.

3. The method of claim 2, further comprising:
using the trend-informed neural network to provide a measure of trust with an output of the trend-aware demand forecasting model.

4. The method of claim 1, further comprising:
quantifying and decomposing uncertainty in an input space and a model space.

5. The method of claim 1, wherein modeling comprises:
learning a sub neural network using an auto-encoder that accounts for a loss function.

6. The method of claim 5, wherein the loss function is configured to describe encoding of a trend forecast.

7. The method of claim 5, further comprising:
determining a reconstruction cost for representing one or more hierarchical constraints for describing uncertainty information associated with the trend forecast.

8. The method of claim 1, further comprising:
determining a value of an impact metric for describing an effectiveness of a trend-aware demand forecast.

9. The method of claim 1, further comprising:
monitoring predictions from the trend-aware demand forecasting model and weather events for a location; and
generating a spatio-temporal demand estimation based on a monitoring results.

10. A computer program product for jointly learning uncertainty-aware trend-informed neural network for a demand forecasting model, the computer program product comprising a computer readable storage medium having program instructions embodied therewith, the program instructions executable by a processing unit to cause the processing unit to perform a method comprising:
training a machine learning model to capture uncertainty in input forecasts;
representing said uncertainty in a latent space using an auto-encoder based neural architecture;
modeling and optimizing the uncertainty-aware latent space to generate an embedding space;
learning a time-series regressor model from the embedding space; and
training a machine learning model for trend-aware demand forecasting based on said time-series regressor model.

11. A processing system comprising at least one processor and the computer program product of claim 10, wherein the at least one processor is adapted to execute computer program code of said computer program product.

12. A system for jointly learning uncertainty-aware trend-informed neural network for a demand forecasting model, the system comprising:
a training component configured to train a machine learning model to capture uncertainty in input forecasts;
a latent space generator configured to represent said uncertainty in a latent space using an auto-encoder based neural architecture;
a modelling component configured to model and optimize the uncertainty-aware latent space to generate an embedding space;
a learning component configured to learn a time-series regressor model from the embedding space; and
a processing unit configured to train a machine learning model for trend-aware demand forecasting based on said time-series regressor model.

13. The system of claim 12, further comprising:
a translation component configured to represent and translate outputs of the trend-aware demand forecasting model using a trend-informed neural network.

14. The system of claim 12, further comprising:
a trust component configured to use the trend-informed neural network to provide a measure of trust with an output of the trend-aware demand forecasting model.

15. The system of claim 12, further comprising the auto-encoder configured to train a sub neural network, wherein the auto-encoder accounts for a loss function.

16. The system of claim 15, wherein the loss function is configured to describe encoding of a trend forecast.
